(19) United States
(12) Patent Application Publication
(10) Pub. No.: US 2008/0229307 A1
(43) Pub. Date: Sep. 18, 2008

(54) WORKFLOW MANAGEMENT SYSTEM

(76) Inventors: Kaoru Maeda, Chiba (JP); Takeshi Suzuki, Kanagawa (JP); Harald Holz, Kaiserslautern (DE); Oleg Rostanin, Kaiserslautern (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/044,364

(22) Filed: Mar. 7, 2008

(30) Foreign Application Priority Data
Mar. 12, 2007 (JP) 2007-062239

(51) Int. Cl. G06F 9/46

(52) U.S. Cl. 718/100

(57) ABSTRACT

A workflow management system wherein a workflow model is dynamically constituted when a workflow is executed, its method, and its computer-executable program are disclosed. The workflow management system includes
a receiving unit for receiving access from an external terminal based on a protocol that is capable accessing a file system;
a providing unit for providing a folder list to the external terminal, wherein the folder list is acquired by converting a task layer of the workflow managed by the workflow management system into a folder layer of the file system; and
an appending unit for appending a document as relevant information to a task of the workflow corresponding to a predetermined folder layer when the document is uploaded by the external terminal.

### BACKGROUND OF THE INVENTION

1. Field of the Invention

The present invention relates to a workflow management system wherein a workflow model is dynamically constituted when a workflow is executed.

2. Description of the Related Art

According to a conventional workflow management system it is necessary to define a workflow model before executing a workflow. However, in the cases of, e.g., research, development and some of service businesses, complete prior information is not available, and for this reason it is difficult to define a precedent workflow model. Then, a method called constructive workflow has been disclosed by, for example, JPA 2005-47792 (Patent Reference 1), and JPA 2005-154261, wherein a model is dynamically structured while executing the workflow.

According to the constructive workflow method, a workflow is dynamically defined by basically assembling workflow components (typical partial workflows) that are beforehand defined.

Further, given that the constructive workflow deals with an atypical business, it is important that a user be provided with various kinds of information relevant to tasks that constitute the workflow. In this connection, various kinds of documents relevant to the tasks (relevant information) can be appended to the tasks, and the user can be timely provided with such relevant information.

Further, the workflow management system can be operated by a Web browser of a client PC (Personal Computer) connected through a network; accordingly, appending a document and perusal of an attached document can be performed from the Web browser.

[Patent Reference 2] JPA 2005-285101

### DISCLOSURE OF THE INVENTION

### Objective of the Invention

Although the conventional workflow management system handling the constructive workflow offers functions of appending a document to the task and perusing a document of the task, the functions are available to a client PC connected to the workflow management system through the network. That is, the function of appending a document to the task is not readily available to a terminal in a mobile environment, where a Client PC cannot be used.

For example, if a person uses a digital camera and takes a photograph of the minutes of a meeting about a task that is an object of the workflow management system, which meeting is held outside of his/her office, he/she cannot append the photograph to the task until he/she returns to the office. That is, appending the latest information is delayed. This problem is common to the cases such as when a memo (text file) is drawn up with a PDA (Personal Digital Assistant) or a cellular phone, not limited to a photograph taken by a digital camera.

In addition, although there are PDAs and cellular phone terminals that are capable of downloading and uploading a file through a network, uploading can be only to a specific folder of a server. That is, they are not capable of specifying a task layer of the workflow, nor capable of generating a new task and appending the file to the new task.

### SUMMARY OF THE INVENTION

The present invention is made to solve the problems described above, and provides a workflow management system that enables a mobile terminal to append a document to a desired task in addition to making reference to a task layer of a workflow and a document appended to the task. Here, the mobile terminal is required to include a protocol capable of accessing file systems, such as FTP (File Transfer Protocol), but is not required to include full-scale software, such as a Web browser.

The workflow management system according to embodiments of the present invention substantially obviates one or more of the problems caused by the limitations and disadvantages of the related art.

Features of embodiments of the present invention are set forth in the description that follows, and in part will become apparent from the description and the accompanying drawings, or may be learned by practice of the invention according to the teachings provided in the description. Problem solutions provided by an embodiment of the present invention may be realized and attained by a workflow management system particularly pointed out in the specification in such full, clear, concise, and exact terms as to enable a person having ordinary skill in the art to practice the invention.

To achieve these solutions and in accordance with an aspect of the invention, as embodied and broadly described herein, an embodiment of the invention provides a workflow management system, wherein a workflow model is dynamically constituted when a workflow is executed, as follows.

### MEANS FOR SOLVING A PROBLEM

The workflow management system according to an aspect of the embodiment of the present invention includes a receiving unit for receiving access from an external terminal based on a protocol that is capable of accessing a file system;

a providing unit for providing the external terminal with a folder layer of a file system that is obtained by converting a task layer of the workflow that is managed by the workflow management system; and

an appending unit for appending a document as relevant information to a task of the workflow corresponding to a predetermined folder layer when the document is uploaded by the external terminal.

According to another aspect of the embodiment, the workflow management system further includes a new task generating unit for generating a new task in a task layer of the workflow based on a request for generating a new folder from the external terminal.

According to another aspect of the embodiment, when a document is uploaded for appending to a folder specified in the folder layer, the appending unit appends the document as relevant information to a task of the workflow corresponding to the folder specified.

According to another aspect of the embodiment, when a document is uploaded for appending with no folder of the folder layer being specified, the appending unit appends the document as relevant information to a task of the workflow based on one of updating time and a keyword of the document.

According to another aspect of the embodiment, when two or more documents are uploaded in a package for appending, the documents are divided into groups based on nearness (proximity) of updating time, and a task is specified for each of the groups.

The embodiment of the present invention provides a workflow control method.

The embodiment of the present invention provides a workflow control program.

### EFFECTIVENESS OF INVENTION

According to the workflow management system of the present invention as embodied herein, a mobile terminal is enabled to append a document to a desired task, in addition to its capability of referring to a task layer of a workflow and an appended document of a task; here, the mobile terminal is required to include a protocol that can access file systems, such as FTP, but is not required to include full-scale software, such as a Web browser. In this way, operability in the mobile environment is remarkably enhanced.

### BRIEF DESCRIPTION OF THE DRAWINGS

FIG. 1 is a block diagram of an example of a workflow management system according to an embodiment of the present invention;

FIG. 2 is a sequence diagram showing an example of a process of a Client PC referring to a task list, and a process of the Client PC acquiring an appended document;

FIG. 3 is a screen display showing an example of a task list as displayed by the Client PC;

FIG. 4 is a sequence diagram showing an example of a process of a mobile terminal referring to a folder list (task list), and a process of the mobile terminal appending a document;

FIG. 5 is a schematic drawing showing an example of corresponding relationships between a task layer and a folder layer;

FIG. 6 is a screen display showing an example of the folder list (task list) displayed at a mobile terminal;

FIG. 7 is a flowchart (No. 1) of an example of a process of converting a task layer to a folder layer;

FIG. 8 is a flowchart (No. 2) of an example of a process of converting the task layer to the folder layer;

FIG. 9 is a flowchart (No. 3) of an example of a process of converting the task layer to the folder layer;

FIG. 10 is a flowchart of an example of a process of appending a document;

FIG. 11 is a sequence diagram showing an example of a process of generating a new folder (task);

FIG. 12 is a flowchart of an example of a process of generating a new folder (task);

FIG. 13 is a sequence diagram of an example of a process of appending documents when the documents are uploaded in a package; and

FIG. 14 is a flowchart of an example of a process of appending documents when the documents are uploaded in a package.

### DESCRIPTION OF THE PREFERRED EMBODIMENTS

In the following, embodiments of the present invention are described with reference to the accompanying drawings.

<System Configuration>

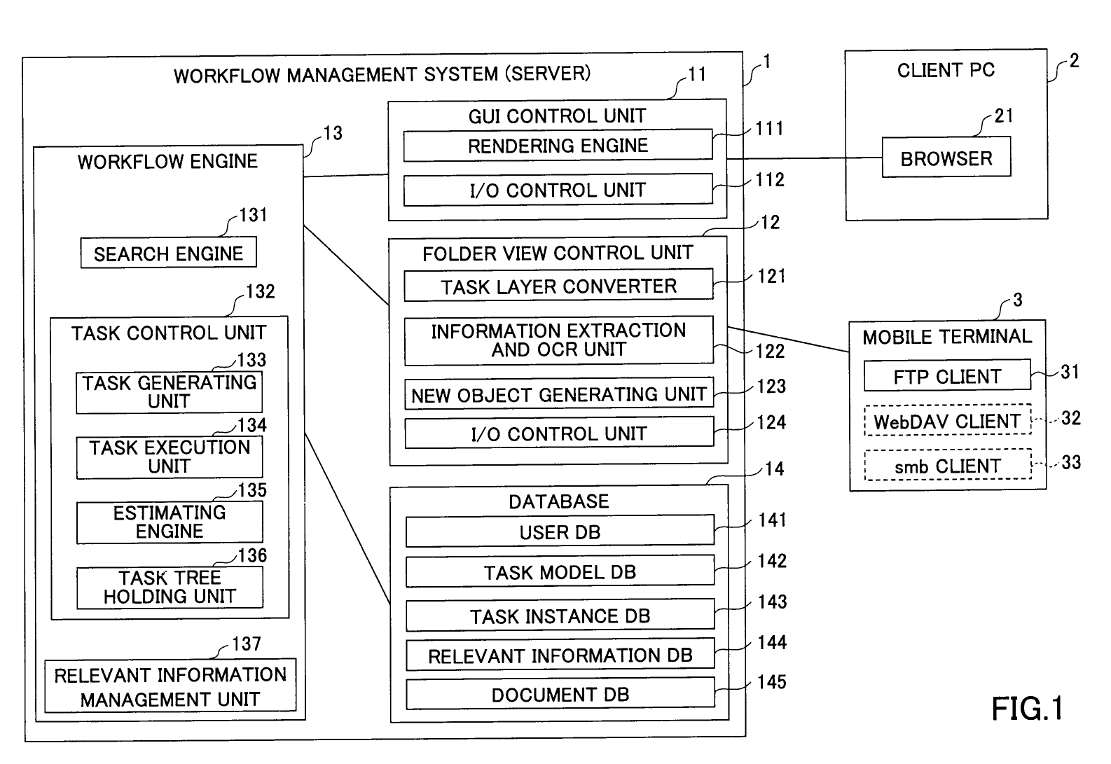

FIG. 1 is a block diagram of an example of a workflow management system 1 according to an embodiment of the present invention.

The workflow management system 1 includes a Client PC 2 and a mobile terminal 3 such as a PDA or a cellular phone that can be connected to the workflow management system 1 through a network. The client PC 2 includes a browser (Web browser) 21. The mobile terminal 3 includes one of an FTP client 31 for accessing a file system by FTP, a WebDAV client 32 for accessing the file system by WebDAV (Web enabled Distributed Authoring and Versioning), and an smb client 33 for accessing the file system by smb (server message block).

The workflow management system 1 includes

a GUI control unit 11 for providing a GUI (Graphical User Interface) for access by the browser 21 of the client PC 2 that is operated by a user of the workflow management system 1, and

a folder view control unit 12

for providing a folder view (folder layer display) corresponding to a task layer of a workflow to be accessed by the FTP client 31, and the like, of the mobile terminal 3 that is operated by a user of the workflow management system 1,

for appending a document (an image file, a text file, etc.) to the task corresponding to the folder, and

for generating a new folder (a new task).

The GUI control unit 11 includes a rendering engine 111 for drawing a display screen, and an I/O control unit 112 for exchanging information with the user.

The folder view control unit 12 includes

a task layer converter 121 for converting a task layer of the workflow into a folder layer,

an information extraction and OCR unit 122 for analyzing a document file (extracting words, etc., of a text file, and extracting words, etc., of an image file after an OCR process) for extracting an identification of the task, where the document file is uploaded for appending by the mobile terminal 3,

a new object generating unit 123 for generating a new object (a new task and a new folder) according to directions of the mobile terminal 3, and

an I/O control unit 124 for controlling input and output of the functional units of the workflow management system 1.

Further, the workflow management system 1 includes a workflow engine 13 for dynamically generating and executing a workflow model by reuse of an existing task model and/or a task instance, and a database 14 for holding information required for processes.

The database 14 includes a user DB 141 for storing information on a user and a user group to which the user belongs; a task model DB 142 for storing a task model beforehand abstracted by a manager, and the like; a task instance DB 143 for storing a task instance; a relevant information DB 144 for storing relevant information that may be referred to when executing a workflow; and a document DB 145 for storing a document file of the relevant information. The information stored in the relevant information DB 144 is linked (associated) with contents of the task model DB 142 and the task instance DB 143.

The workflow engine 13 includes a search engine 131 for searching the database 14, a task control unit 132 for controlling tasks that constitute the workflow, and a relevant information management unit 137 for managing the relevant information DB 144 and the document DB 145.

The task control unit 132 includes a task generating unit 133 for generating a task, a task execution unit 134 for executing the generated task, an estimating engine 135 for estimating a user's present task and for searching the database 14 for related information, and a task tree holding unit 136 for managing a task layer in a tree format.

When the new object generating unit 123 generates a new object, the task generating unit 133 generates the new task.

Basic operations of workflow control include that the user operates the workflow engine 13 through the I/O control unit 112 of the GUI control unit 11 such that a workflow may be generated and executed, a workflow model may be generated, relevant information and a document may be stored, and the relevant information and the document may be linked with the workflow instance and the workflow model.

When generating the workflow, the search engine 131 of the workflow engine 13 searches the database 14 for various information items.

The task control unit 132 of the workflow engine 13 uses the task model DB 142 and the task instance DB 143, and controls a task based on user directions, and the like. The task generating unit 133 of the task control unit 132 generates the task, and provides linkage of the information, etc., based on the information stored in the database 14 according to the user directions. The task execution unit 134 uses the information stored in the task instance DB 143 according to user directions, and updates actual task information. Here, updating the task information is a task execution if viewed from the workflow management system.

<Operation>

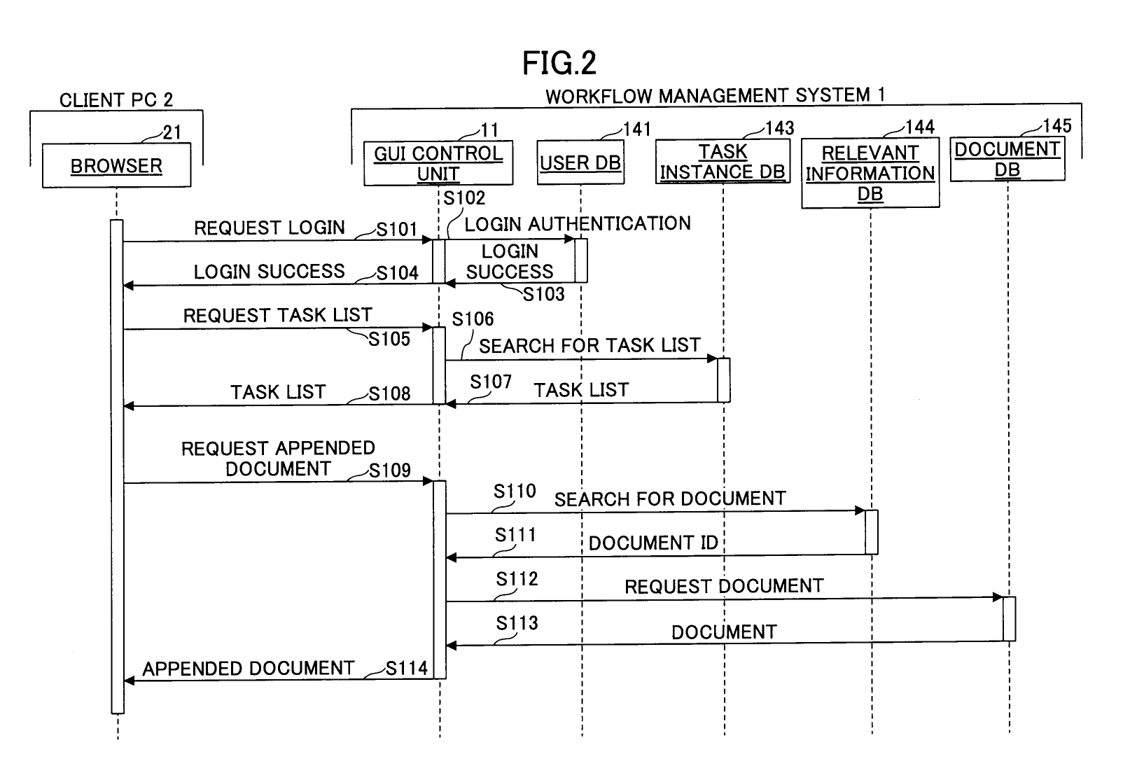

FIG. 2 is a sequence diagram of an example of a process of viewing a task list and acquiring an appended document by the client PC 2.

In FIG. 2, a login is requested from the browser 21 of the client PC 2 to the GUI control unit 11 of the workflow management system 1 (step S101), then, the GUI control unit 11 requests a login authentication by the user DB 141 (step S102). If the login request is authenticated (step S103), the GUI control unit 11 returns a “login success” to the browser 21 of the client PC 2 (step S104).

Subsequently, the browser 21 of the client PC 2 requests a task list 201 from the GUI control unit 11 of the workflow management system 1 (step S105); then, the GUI control unit 11 searches the task instance DB 143 for a task list of the login user (step S106). If the task list 201 is acquired (step S107), the GUI control unit 11 provides the acquired task list 201 to the browser 21 of the client PC 2 (step S108).

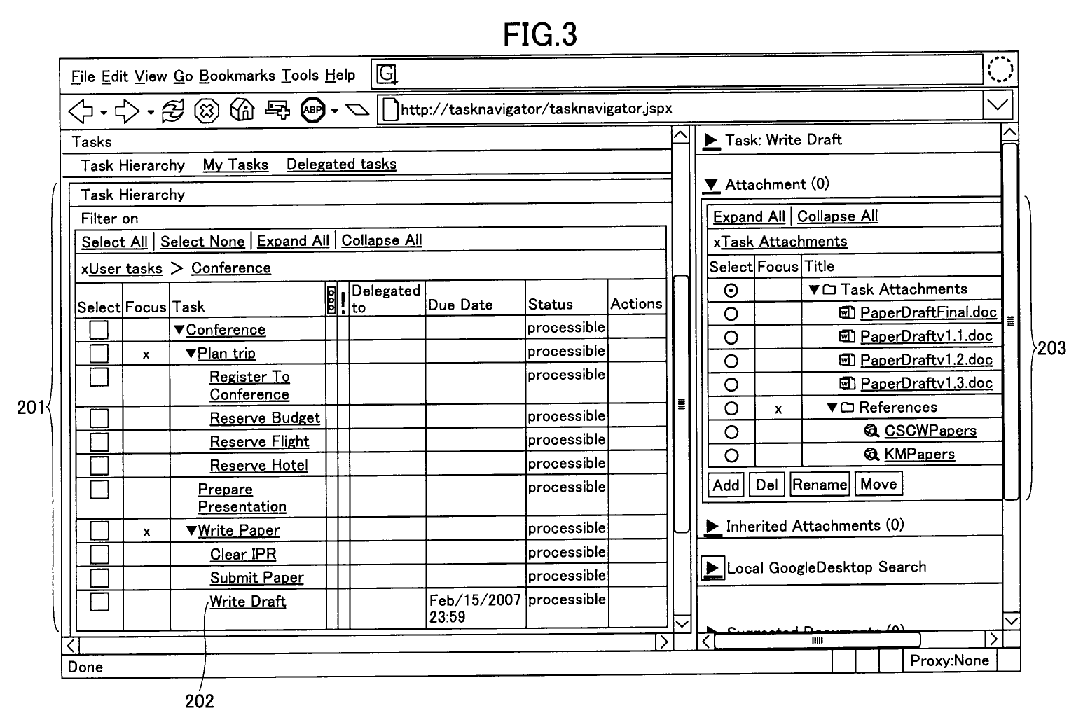

FIG. 3 shows an example of a screen display of the task list 201 displayed at the client PC 2, wherein the task list 201 hierarchically presents tasks related to the login user. If one of the tasks is selected (a selected task 202), an appended document list 203 displays appended documents related to the selected task 202. In the appended document list 203, document names, e.g., “PaperDraftFinal.doc”, are presented under an appended document folder (appended information category), namely, “Task Attachments”.

Returning to FIG. 2, the browser 21 of the client PC 2 requests an appended document from the GUI control unit 11 of the workflow management system 1 (step S109); the GUI control unit 11 searches the relevant information DB 144 for an ID of the requested document (step S110), and acquires a Document ID (step S111).

Then, the GUI control unit 11 acquires the requested document from the document DB 145 based on the Document ID (steps S112 and S113), and provides the requested appended document to the browser 21 of the client PC 2 (step S114).

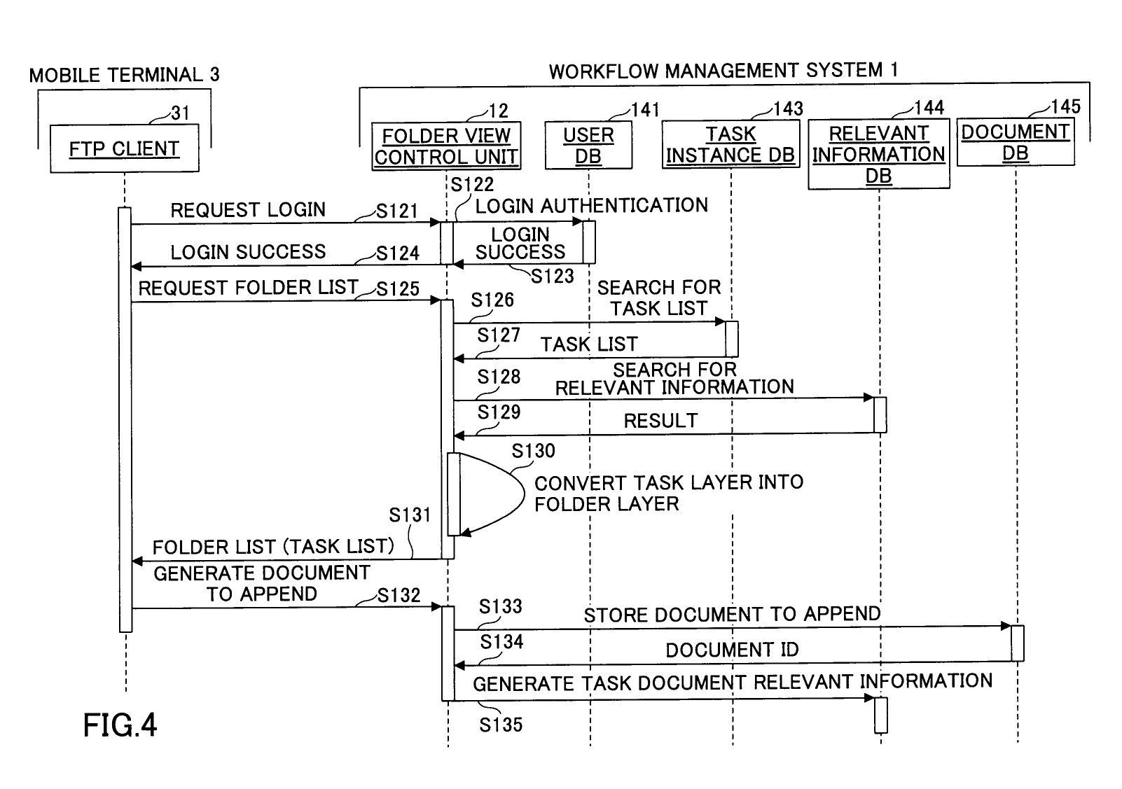

FIG. 4 is a sequence diagram showing an exemplary case wherein the mobile terminal 3 displays the folder list (task list), and appends a document. Here, according to the example, an access is made by the FTP client 31 of the mobile terminal 3; however, the same operation is applicable to the case wherein one of the WebDAV client 32 and the smb client 33 makes the access.

In FIG. 4, the FTP client 31 of the mobile terminal 3 sends a login request to the folder view control unit 12 of the workflow management system 1 (step S121), then the folder view control unit 12 requests login authentication of the user by the DB 141 (step S122), and if the login is authenticated (step S123), the folder view control unit 12 provides a “login success” to the FTP client 31 of the mobile terminal 3 (step S124).

Then, the FTP client 31 of the mobile terminal 3 requests the folder list (although the folder list is formally requested, the task list is essentially requested) from the folder view control unit 12 of the workflow management system 1 (step S125). Then, the folder view control unit 12 of the workflow management system 1 searches the task instance DB 143 for the task list related to the login user (step S126), and acquires the task list (step S127).

Subsequently, the folder view control unit 12 searches the relevant information DB 144 for relevant information (step S128), and acquires the search results (relevant information and a task layer) (step S129).

Subsequently, the folder view control unit 12 converts the acquired task layer into a folder layer (step S130), and provides the folder list (obtained by converting the task list) to the FTP client 31 of the mobile terminal 3 (step S131). That is, the task layer of the workflow management system 1 is converted into the folder layer so that the folder list may be provided for viewing at the FTP client 31 of the mobile terminal 3. The relevant information appended to the task is converted into a file so that it may be visible in the folder.

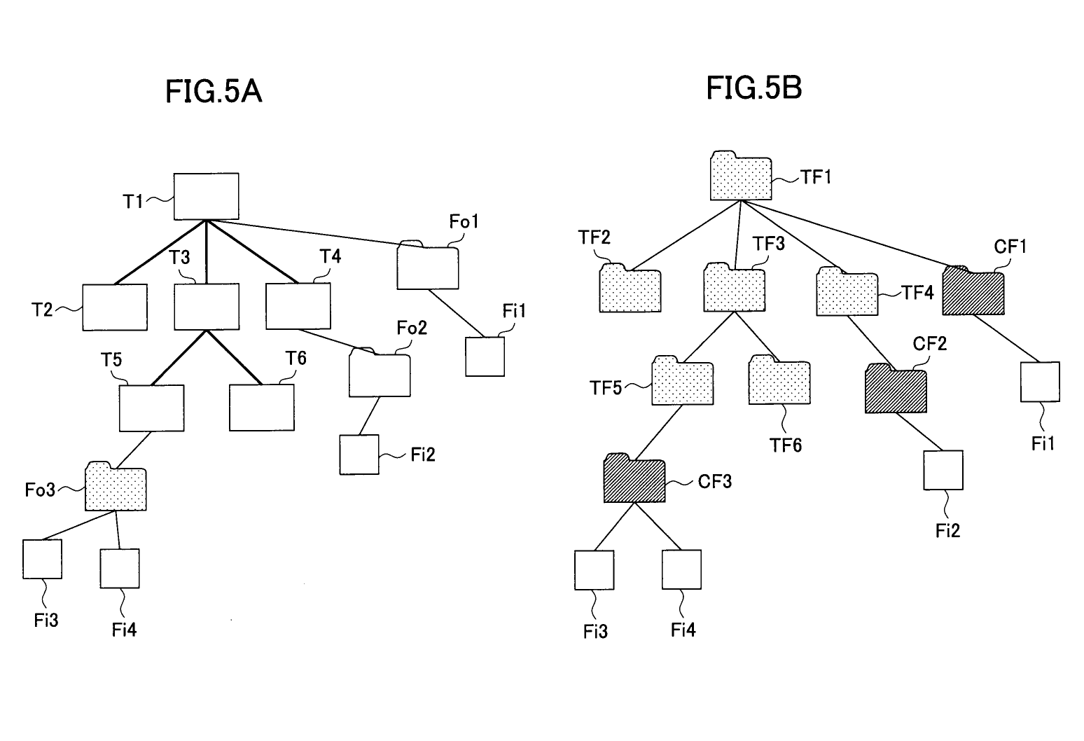

FIG. 5 shows an example of corresponding relationships between the task layer and the folder layer, wherein on the left-hand side at (a), the task layer before conversion is shown, and on the right-hand side at (b), the folder layer after conversion is shown.

As for the task layer at (a), a task T1 includes subtasks T2 through T4 (connected by bold lines). Further, the subtask T3 includes subtasks T5 and T6 (connected by bold lines). The task T1 includes an appended information category Fo1 that accommodates an attached file (appended document) Fi1. The subtask T4 includes an appended information category Fo2 that accommodates an attached file Fi2. The subtask T5 includes an appended information category Fo3 that accommodates attached files Fi3 and Fi4.

As for the folder layer at (b), task corresponding folders (folders that are converted from tasks) TF1 through TF6 are shown, which correspond to the tasks/subtasks T1 through T6, respectively, shown at (a), wherein the hierarchical structure is maintained. The appended information category Fo1 associated with the task T1 at (a) is converted to a category corresponding folder CF1 (folder that is converted from appended information category) at (b), wherein the CF1 directly belongs to the task corresponding folder TF1. In this way, although there are cases wherein a class category (appended information category) is added to a task as appending information in order to arrange the information appended to a task, since it is natural to show such a classification configuration as a folder when accessing by a protocol such as FTP, it is converted into the category corresponding folder.

The attached file Fi1 accommodated in the appended information category Fo1 at (a) is accommodated in the category corresponding folder CF1 at (b). The appended information category Fo2 under the subtask T4 at (a) corresponds to a category corresponding folder CF2 directly under the task corresponding folder TF4 at (b). The attached file Fi2 accommodated in the appended information category Fo2 at (a) is accommodated in the category corresponding folder CF2 at (b). The appended information category Fo3 under the subtask T5 at (a) corresponds to a category corresponding folder CF3 directly under the task corresponding folder TF5 at (b). The attached files Fi3 and Fi4 accommodated in the appended information category Fo3 at (a) are accommodated in the category corresponding folder CF3 at (b).

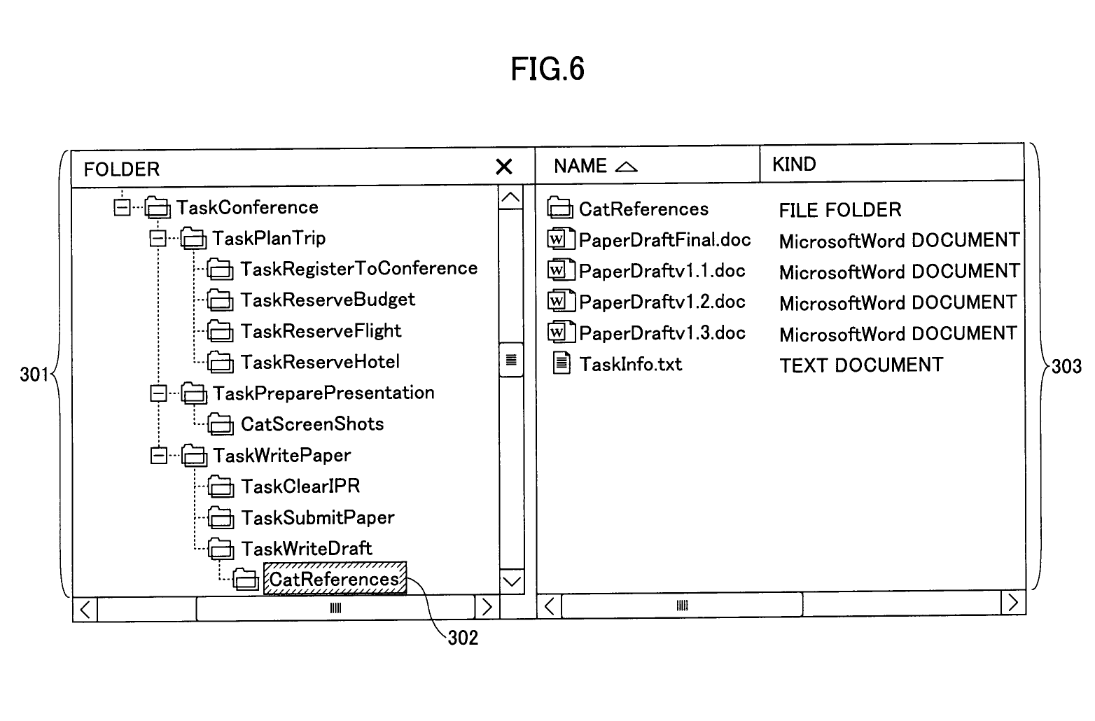

FIG. 6 shows an example of the folder list (task list) displayed at the mobile terminal 3, and corresponds to the task layer shown in FIG. 3. Here, the specific display format may vary with applications of the mobile terminal 3.

With reference to FIG. 6, a folder layer column 301 gives a hierarchical display of the folders (the task corresponding folder or the category corresponding folder, as applicable) obtained by converting the tasks and the appended information categories. In order to clarify the corresponding relationship between a task and an appended information category, “Task” is prefixed to a task corresponding folder name, and “Cat” is prefixed to a category corresponding folder name.

An appended file column 303 shows contents (a lower category corresponding folder and appended files) of a selected folder 302 (“CatReferences” folder in this example) that is selected in the folder layer column 301.

With reference to FIG. 4, again, the FTP client 31 of the mobile terminal 3 requests the folder view control unit 12 of the workflow management system 1 to append a document that is attached to the request into a folder (task) that is specified by the request (step S132). The request from the FTP client 31 of the mobile terminal 3 to append the document is communicated using a standard file download/upload process. Then, the folder view control unit 12 stores the document to be appended in the document DB 145 (step S133), and acquires a document ID for identifying the stored document (step S134).

Then, the folder view control unit 12 generates task document relevant information and stores the information in the relevant information DB 144 (step S135). In this way, the document is appended to the specified task.

Here, correspondence of the task layer to the folder layer is summarized:
Viewing the task layer: Viewing the folder layer
Viewing information appended to the task: Viewing the file in the folder, and viewing the sub folder
Appending information to the task: Uploading the file (put)
Updating information on appended documents: Overwriting upload
Generating a new subtask: Generating a folder
Bibliographic information of the task: an information file having a specific file name (TaskInfo.Txt)

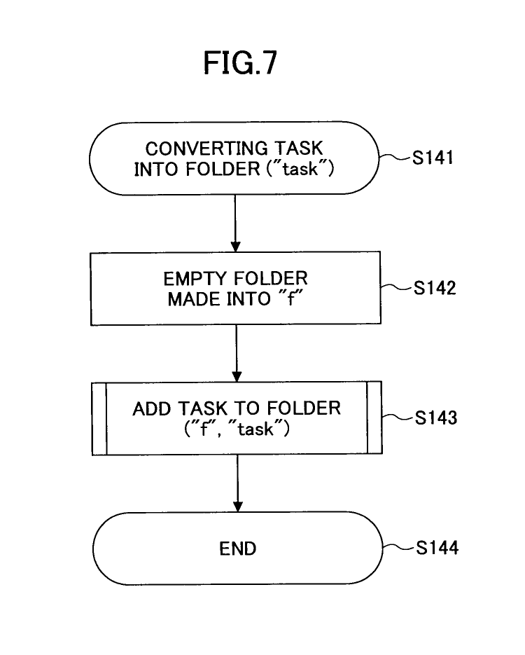

FIGS. 7 through 9 are flowcharts showing an example of a process of converting (step S130) from the task layer to the folder layer as shown in FIG. 4.

First, a process of “conversion of a task into a folder” is described with reference to FIG. 7.

The process of “conversion of a task into a folder” is performed with a target task (a task included in a task list) “task” serving as a parameter (step S141). Then, an empty folder is generated serving as a folder “f” (step S142).

Subsequently, a process of “adding the task to the folder” (step S143) is performed with the folder “f” and the “task” serving as parameters, and the process is ended (step S144).

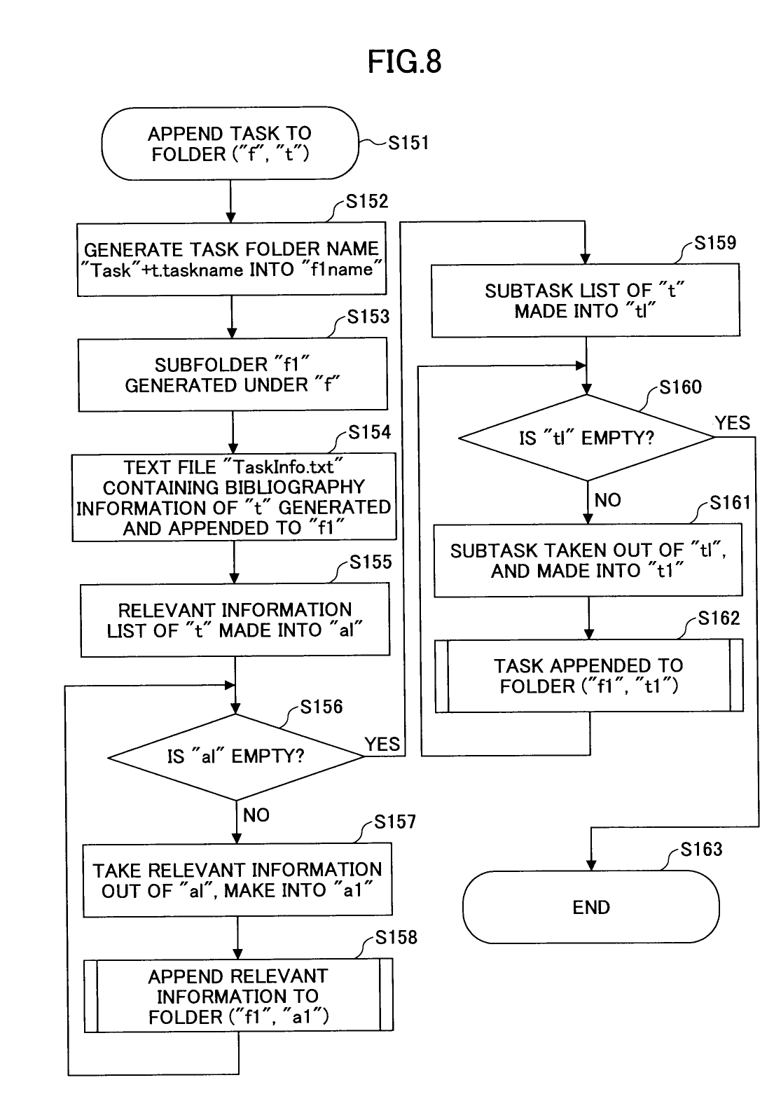

FIG. 8 is a flowchart showing an example of processes performed at the step S143, “adding the task to the folder”.

With reference to FIG. 8, when “adding the task to the folder” is started (step S151) with the folder “f” and task “t” serving as the parameters, a task folder name is first generated (step S152). That is, a character string “Task” is prefixed to a task name (t. task name (task name property of an object t)) to make a task folder name “f1name”.

Subsequently, a sub folder “f1” is generated under the folder “f”; and then, the task folder name “f1name” is assigned as the name of the folder “f1” (f1.name) (step S153).

Subsequently, bibliographic information of the task “t” is written to a text file “TaskInfo.txt”, and the text file is stored in the sub folder “f1” (step S154).

Subsequently, a list of relevant information of the task “t” is made into a list “al” (step S155).

Then, whether the list “al” is empty is determined (step S156).

If the list “al” is not empty (No at step S156), the relevant information is taken out from the list “al”, and is made into an item “al” (step S157).

Subsequently, at step S158, the item “al” is added to the folder “f1”. Then, the process returns to the step S156 for determining whether the list “al” is empty.

Otherwise, if the list “al” is empty (Yes at step S156), a subtask list of the task “t” is made into a list “tl” (step S159).

Then, whether the list “tl” is empty is determined (step S160).

If the list “tl” is not empty (No at step S160), a subtask is taken out from the list “tl”, and is made into a “task t1” (step S161).

Subsequently, “adding a task to the folder” by the steps S151 through S163 is recursively carried out (step S162) with the folder “f1” and the task “t1” serving as the parameters. Then, the process returns to the step S160 for determining whether the list “tl” is empty.

If the list “tl” is empty (Yes at step S160), the process is ended (step S163).

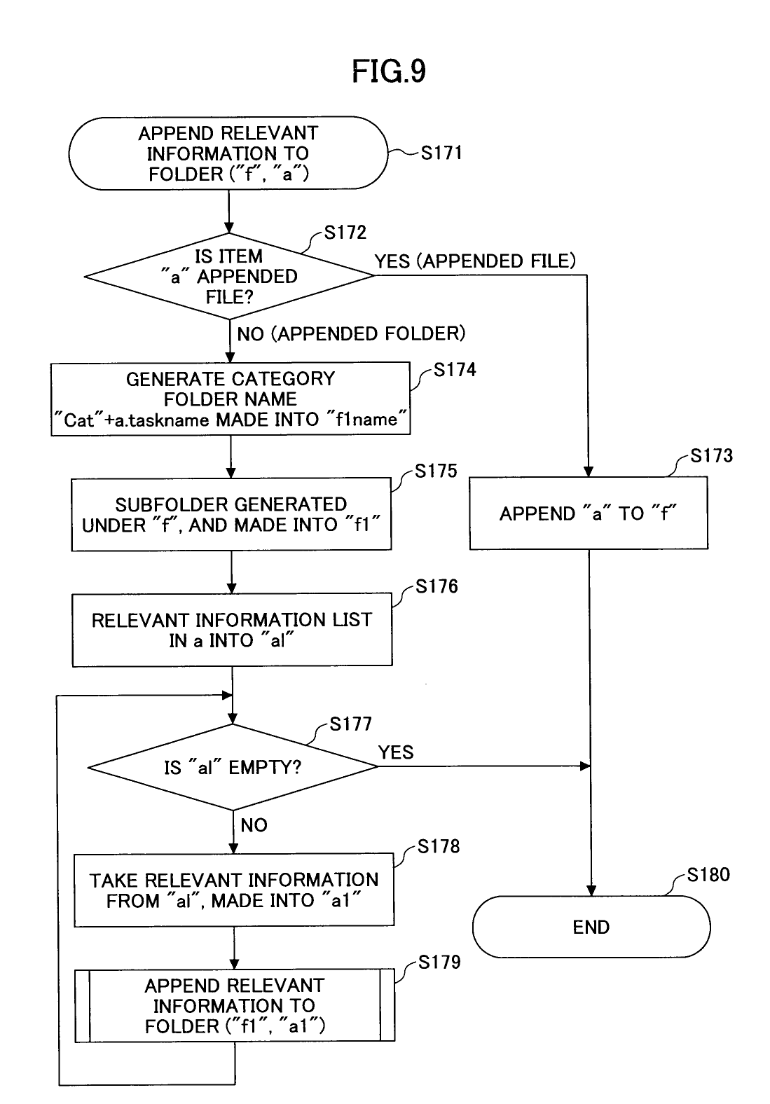

FIG. 9 is a flowchart of an example of processes of the step S158, “adding relevant information to the folder”.

When “adding relevant information to the folder” (S171) is started with the folder “f” and an item “a” serving as parameters in FIG. 9, whether the item “a” is an appended file is first determined (step S172).

If the item “a” is an appended file (Yes at step S172), the item “a” is added to the folder “f” (step S173), and the process is ended (step S180).

Otherwise, if the item “a” is not an appended file (No at step S172) (i.e., if it is an appended folder), a category folder name “f1name” is generated, wherein a character string “Cat” is prefixed to the task name (a.task name) (step S174).

Subsequently, a sub folder “f1” is generated under the folder “f”; further, the category folder name “f1name” already generated is made into the name of the sub folder “f1” (f1.name) (step S175).

Subsequently, the relevant information list in the item “a” is made into the list “al” (step S176).

Then, whether the list “al” is empty is determined (step S177).

If the list “al” is not empty (No at step S177), the relevant information is taken out from the list “al”, and is made into the item “a1” (step S178).

Subsequently, “adding the relevant information to the folder”, i.e., the steps S171 through S180, is recursively carried out (step S179) with the “folder “f1”” and the item “a1” serving as the parameters. Then, the process returns to the step S177 for determining whether the list “al” is empty.

If the list “al” is empty (Yes at step S177), the process is ended (step S180).

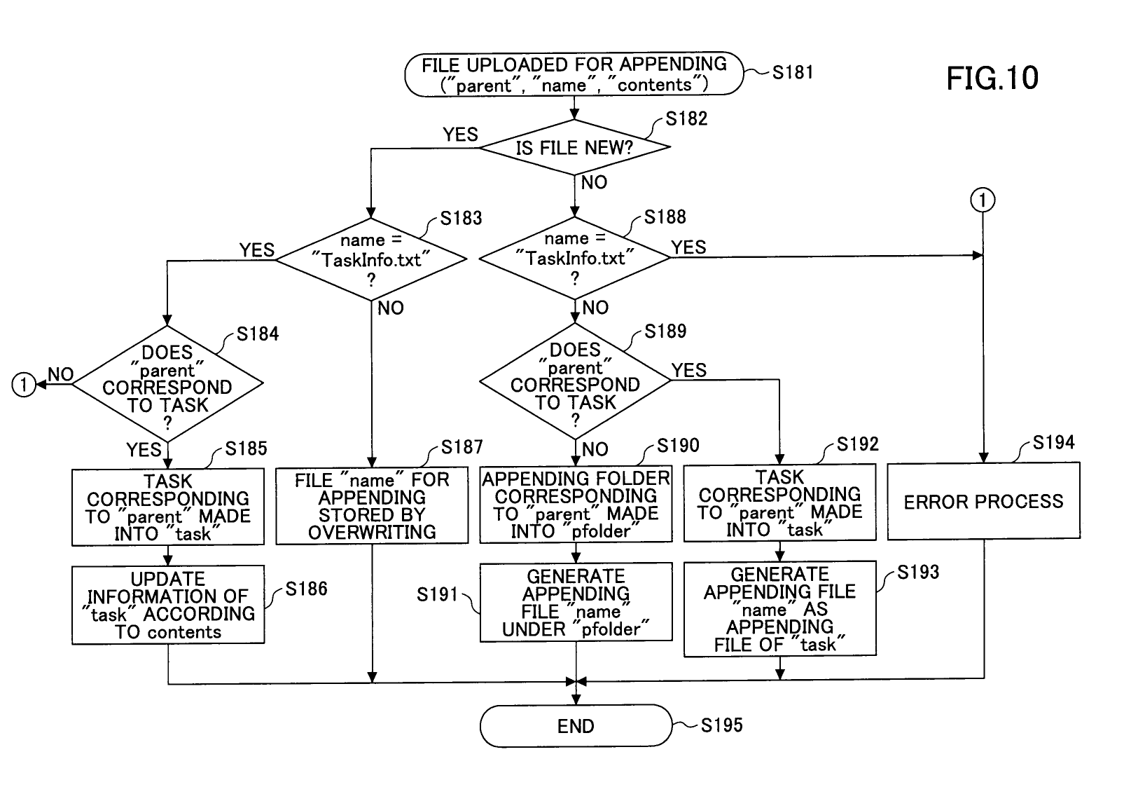

FIG. 10 is a flowchart of an example of processes of the steps S133 through S135, “appending a document” shown in FIG. 4.

With reference to FIG. 10, when “uploading an attachment file” is started (step S181) with a parent item (“parent”), an attachment file name (“name”), and contents (“contents”) serving as the parameters, whether the attachment file bearing the attachment file name is a new file is determined (step S182).

If the attachment file is a new file (Yes at step S182), whether the attachment file name (“name”) is “TaskInfo.txt” is determined (step S183).

If the attachment file name (“name”) is “TaskInfo.txt” (Yes at step S183), whether the parent item (“parent”) corresponds to a task is determined (step S184).

If the parent item does not correspond to a task (No at step S184), the process moves to step S194 for error handling, and the process is ended (step S195).

If the parent item corresponds to a task (Yes at step S184), the task that corresponds to the parent item (“parent”) is made into the task (“task”) (step S185).

Subsequently, information about the task (“task”) is updated according to the contents (“contents”) (step S186), and the process is ended (step S195).

If the attachment file name (“name”) is not “TaskInfo.txt” (No at step S183), the file having the attachment file name (“name”) is overwritten by the new file (step S187), and the process is ended (step S195).

Otherwise, if the uploaded file to be appended is not a new file (No at step S182), whether the attachment file name (“name”) is “TaskInfo.txt” is determined (step S188).

If the attachment file name (“name”) is “TaskInfo.txt” (Yes at step S188), the process moves to step S194 for error handling, and the process is ended (step S195).

If the attachment file name (“name”) is not “TaskInfo.txt” (No at step S188), whether the parent item (“parent”) corresponds to the task is determined (step S189).

If the parent item does not correspond to the task (No at step S189), an appending folder corresponding to the parent item (“parent”) is made into a folder “pfolder” (step S190).

Subsequently, a file having the attachment file name (“name”) is generated under the folder “pfolder” (step S191), and the process is ended (step S195).

Otherwise, if the parent item corresponds to a task (Yes at step S189), the task corresponding to the parent item (“parent”) is made into the task (“task”) (step S192).

Subsequently, a file having the attachment file name (“name”) is generated and is attached to the task (“task”) (step S193), and the process is ended (step S195).

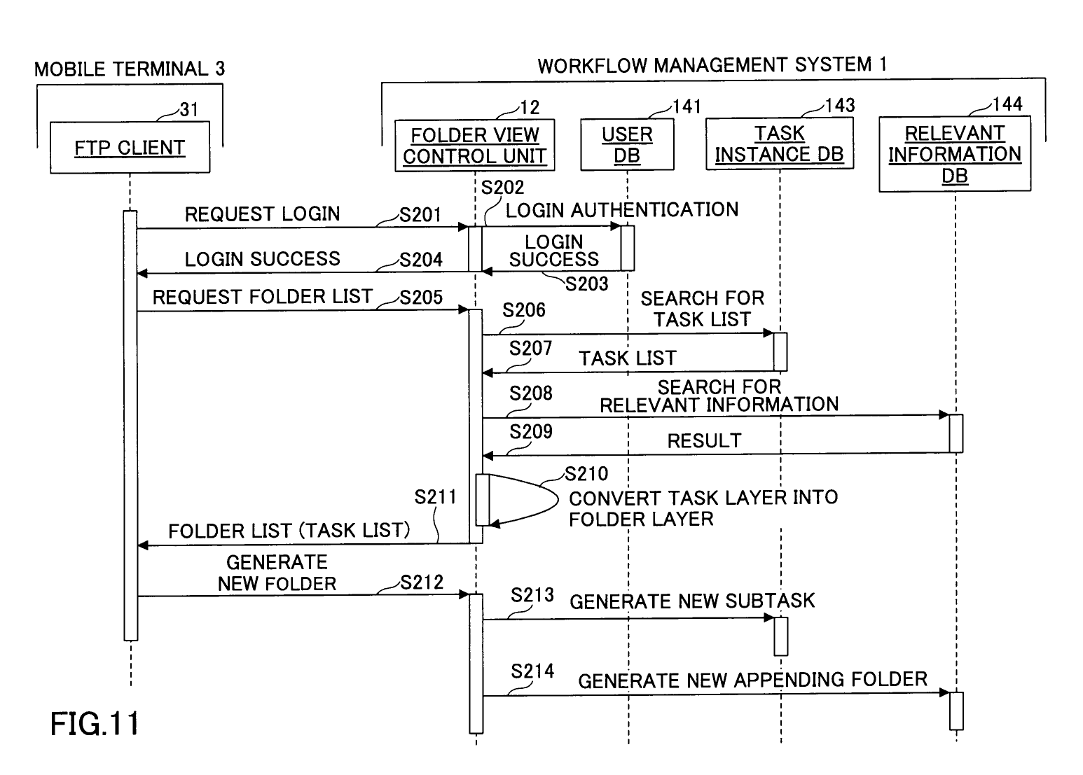

FIG. 11 is a sequence diagram showing an example of a new folder (“task”) generating process.

With reference to FIG. 11, the FTP client 31 of the mobile terminal 3 sends a login request to the folder view control unit 12 of the workflow management system 1 (step S201), and the folder view control unit 12 requests a login authentication from the user DB 141 (step S202). If logging in is authenticated (step S203), the folder view control unit 12 provides a “login success” to the FTP client 31 of the mobile terminal 3 (step S204).

Subsequently, the FTP client 31 of the mobile terminal 3 requests a folder list (which essentially is a task list while the folder list is formally requested) from the folder view control unit 12 of the workflow management system 1 (step S205), and the folder view control unit 12 searches the task instance DB 143 for the task list concerning the login user (step S206), and acquires the task list (step S207).

Subsequently, the folder view control unit 12 searches the relevant information DB 144 for relevant information (step S208), and acquires a search result (task layer and relevant information) (step S209).

Subsequently, the folder view control unit 12 converts the task layer into the folder layer (step S210), and provides the folder list (obtained by converting the task list) to the FTP client 31 of the mobile terminal 3 (step S211).

Then, the FTP client 31 of the mobile terminal 3 requests the folder view control unit 12 of the workflow management system 1 to generate a new folder (step S212), and the folder view control unit 12 generates a new subtask in the task instance DB 143 (step S213). If the user gives a prefix when requesting the generation of the folder, the subtask and a sub category can be generated.

Subsequently, the folder view control unit 12 generates a new appending folder in the relevant information DB 144 (step S214).

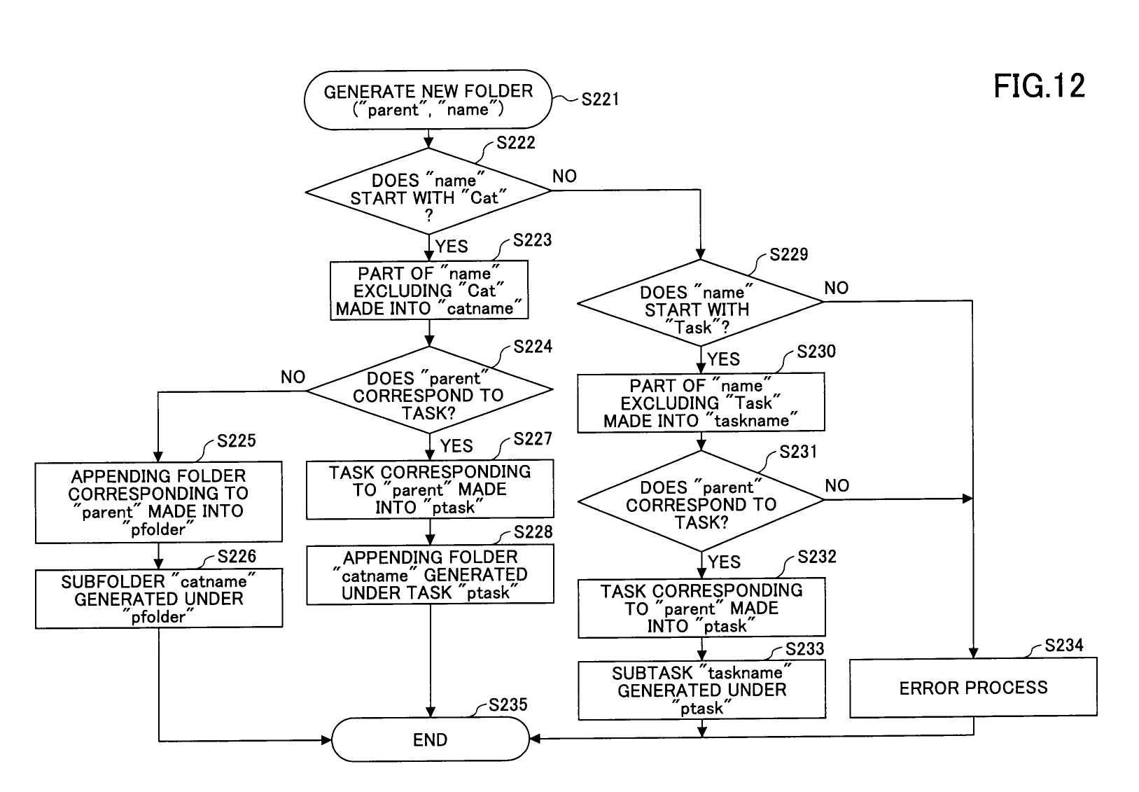

FIG. 12 is a flowchart showing an example of processes of the new folder (“task”) generation (steps S212 through S214 of FIG. 11).

A process of generating a new folder is started with the parent item (“parent”) and the name (“name”) serving as the parameters (step S221) as shown in FIG. 12. Then, whether the name (“name”) starts with “Cat” is first determined (step S222).

If it is determined that the name (“name”) starts with “Cat” (Yes at step S222), a part of the name (“name”) excluding “Cat” is made into a “name catname” (step S223).

Next, whether the parent item (“parent”) corresponds to a task is determined (step S224).

If the parent item (“parent”) does not correspond to a task (No at step S224), an appending folder corresponding to the parent item (“parent”) is made into a folder “pfolder” (step S225).

Subsequently, a “sub folder catname” is generated under the appending folder “pfolder” (step S226), and the process is ended (step S235).

If the parent item (“parent”) corresponds to a task (Yes at step S224), the task corresponding to the parent item (“parent”) is made into a task “ptask” (step S227).

Subsequently, the appending folder “catname” is generated under the task “ptask” (step S228), and the process is ended (step S235).

If the name (“name”) does not start with “Cat” (No at step S222), whether the name (“name”) starts with “Task” is determined (step S229).

If the name (“name”) does not start with “Task” (No at step S229), an error process at step S234 is carried out, and the process is ended at step S235.

If the name (“name”) starts with “Task” (Yes at step S229), a part of the name (“name”) excluding “Task” is made into a name “taskname” (step S230).

Next, whether the parent item (“parent”) corresponds to a task is determined (step S231).

If the parent item (“parent”) does not correspond to a task (No at step S231), the error process is carried out at step S234, and the process is ended at step S235.

If the parent item (“parent”) corresponds to a task (Yes at step S231), the task corresponding to the parent item (“parent”) is made into the task “ptask” (step S232).

Then, a “subtask taskname” is generated under the task “ptask” (step S233), and the process is ended at step S235.

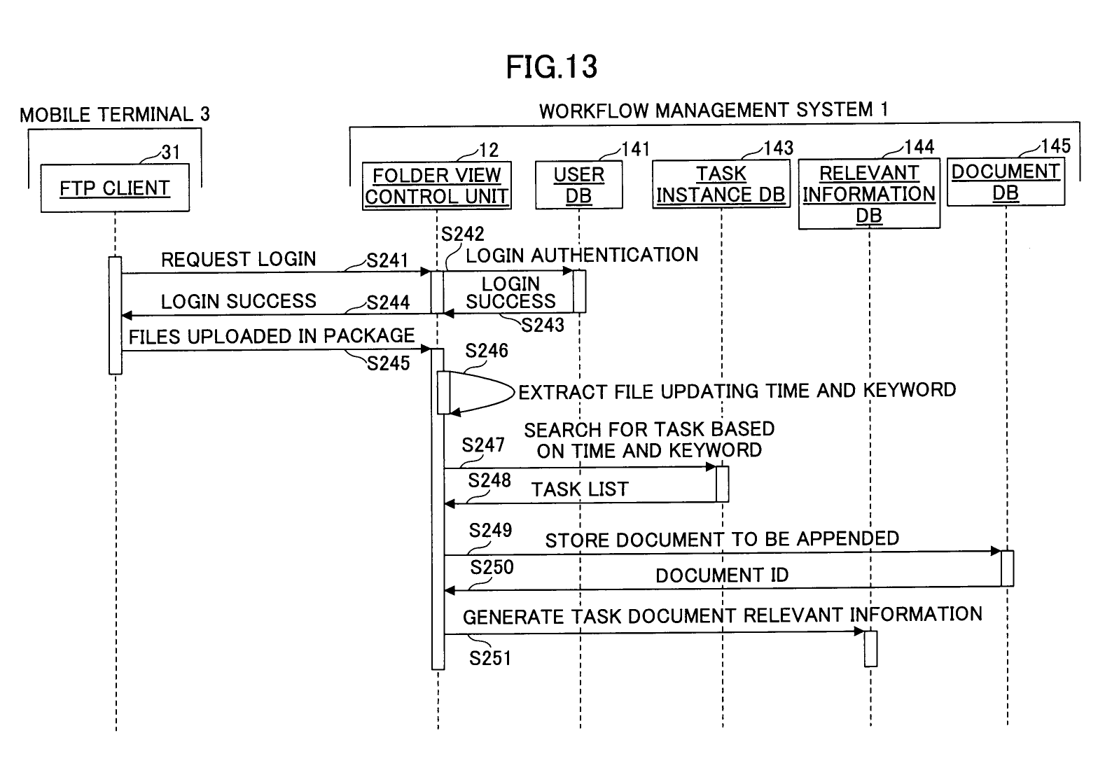

FIG. 13 is a sequence diagram of an example of a process of appending documents that are uploaded in a package.

With reference to FIG. 13, the FTP client 31 of the mobile terminal 3 requests to login to the folder view control unit 12 of the workflow management system 1 (step S241). Then, the folder view control unit 12 requests a login authentication by the user DB 141 (step S242). If the login is authenticated (step S243), the folder view control unit 12 provides a “login success” to the FTP client 31 of the mobile terminal 3 (step S244).

Then, files are uploaded in a package by the FTP client 31 of the mobile terminal 3 to the folder view control unit 12 of the workflow management system 1 (step S245), and the folder view control unit 12 extracts file-updating times and keywords from the uploaded files (step S246). If the uploaded files include a file containing an image taken with a digital camera, time of picture taking, GPS (Global Positioning System) location information, etc., can be acquired from an Exif (Exchangeable Image File Format). If the image is obtained by scanning an image of a document, a keyword is extracted by using an OCR technique. If the file is an ordinary text file, the updating time, the keyword, etc., can be directly acquired from the file. Then, the files are grouped (clustering) according to the nearness (proximity) of the time using the updating times acquired as described above.

Subsequently, the folder view control unit 12 searches the task instance DB 143 for a task based on the time and the keyword that are extracted (step S247), and acquires a task list (step S248). That is, if there is a task that is or will be executed at the time, a keyword of which task is present in the task instance DB 143, tasks containing the keyword are searched for. Here, information about grouping described above is utilized; that is, searching is carried out for each group; in this way, a minor time difference is disregarded. Since grouping is carried out based on the updating time, tasks can be searched for based on more information. Further, when keyword information is acquirable from the uploaded files, a ranking search of the task instance DB 143 is carried out with the keywords of all the files included in a group serving as search conditions, and a task of the highest position in the tree hierarchy is identified.

Subsequently, the folder view control unit 12 stores the appended documents in the document DB 145 (step S249), and acquires document IDs for identifying the stored documents (step S250).

Subsequently, the folder view control unit 12 generates task document relevant information and stores the same in the relevant information DB 144 (step S251) in association with the already specified task. If no task corresponding to the group can be specified, and if there is a task that corresponds to another group, association is made with the parent task.

In the above, the descriptions are made wherein two or more documents are uploaded in a package without specifying a folder in the folder layer; however, even if a single document is uploaded without specifying a folder in the folder layer, the document can be appended as relevant information by specifying a task based on one of the updating time and the keyword of the document.

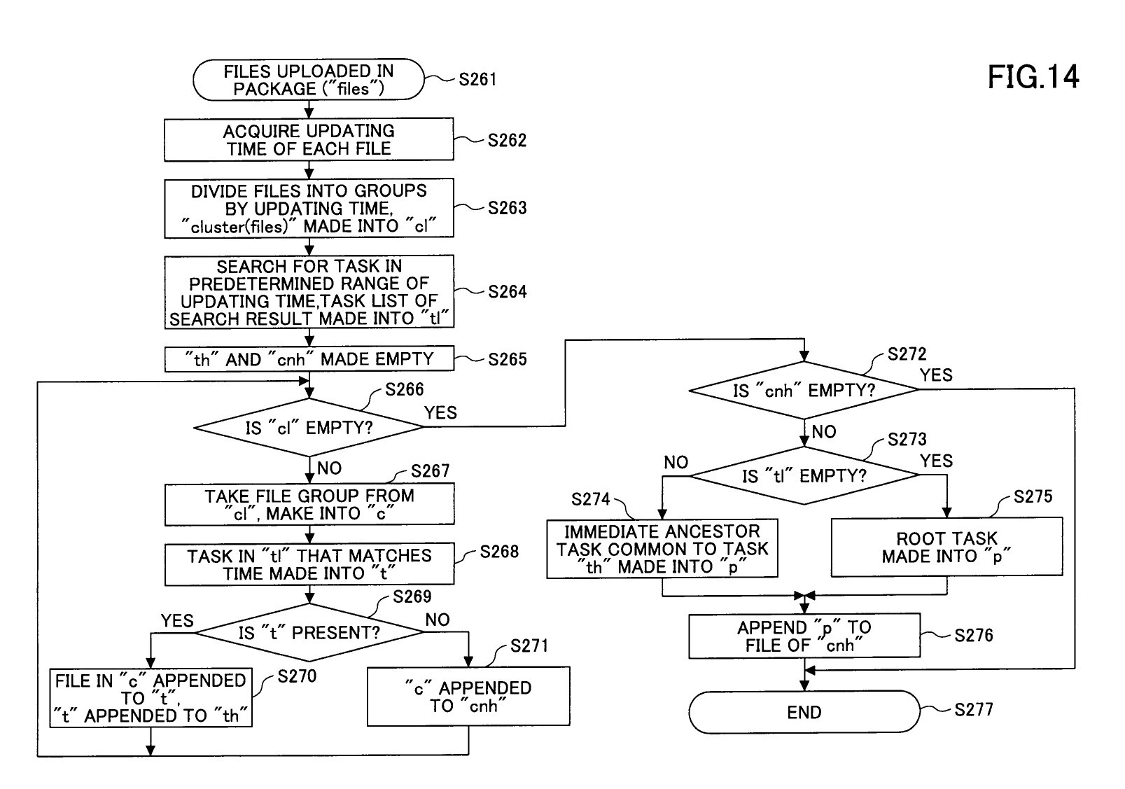

FIG. 14 is a flowchart showing an example of the process of uploading files in a package (steps S245 through S251) of FIG. 13.

With reference to FIG. 14, “file package uploading” is started with files (“files”) serving as the parameter (step S261). Then, updating time of each file is acquired (step S262).

Then, the files are divided into groups according to updating time (step S263). That is, a cluster function “cluster (files)” is applied to the files (“files”), and a result is made into a list “c1”.

Then, a task is searched for in a range between two limits of the updating times, and a task list obtained as a search result is made into a list “tl” (step S264).

Subsequently, an item “th” is made empty, and an item “cnh” is made empty (step S265).

Then, it is determined whether the list “c1” is empty (step S266).

If the list “c1” is not empty (No at step S266), a file group is taken out from the list “c1” and is made into an item “c” (step S267).

Then, a task whose time corresponds to the item “c” in the list “tl” is made into the task “t” (step S268).

Subsequently, it is determined whether the task “t” is present (step S269).

If the task “t” is present (Yes at step S269), the file of the item “c” is appended to the task “t”, and the task “t” is added to the item “th” (step S270). Then, the process returns to step S266 where it is determined whether the list “c1” is empty.

When the task “t” is not present (No at step S269), the item “c” is added to the item “cnh” (step S271), and the process returns to step S266 where it is determined whether the list “c1” is empty.

If the list “c1” is empty (Yes at step S266), whether the item “cnh” is empty is determined (step S272).

If the item “cnh” is empty (Yes at step S272), the process is ended (step S277).

If the item “cnh” is not empty (No at step S272), whether the item “th” is empty is determined (step S273).

If the item “th” is not empty (No at step S273), an immediate ancestor task that is common to the task of the item “th” is made into an item “p” (step S274).

If the item “th” is empty (Yes at step S273), a root task is made into the item “p” (step S275).

Then, the file of the item “cnh” is appended to the item “p” (step S276), and the process is ended (step S277).

<Summary>

As described above, advantages of the embodiments of the present invention are as follows.

(1) Since the task layer is mapped to the folder layer, a mobile terminal that has a protocol such as FTP, WebDAV, and smb for handling a layer file system is capable of accessing the workflow management system, and capable of handling the layer task and its appended information with an existing (conventional) client function.

(2) Since an image provided by an image pick-up device, a file transmitted from a PDA, and the like, can be appended to a task that is determined based on updating time, they can be easily associated with a task that is carried out, or that is to be carried out at the corresponding time.

(3) By placing two or more files into groups by comparing the updating time of a file with others, a task can be selected with great accuracy.

Further, the present invention is not limited to these embodiments, but variations and modifications may be made without departing from the scope of the present invention.

The present application is based on Japanese Priority Application No. 2007-062239 filed on Mar. 12, 2007 with the Japanese Patent Office, the entire contents of which are hereby incorporated by reference.

What is claimed is:

1. A workflow management system wherein a workflow model is dynamically constituted when a workflow is executed, the workflow management system comprising:
a receiving unit for receiving an access from an external terminal based on a protocol that is capable of accessing a file system;
a providing unit for providing a folder list to the external terminal, wherein the folder list is acquired by converting a task layer of the workflow managed by the workflow management system into a folder layer of the file system; and
an appending unit for appending a document as relevant information to a task of the workflow corresponding to a predetermined folder layer when the document is uploaded by the external terminal.

2. The workflow management system as claimed in claim 1, further comprising:
a new task generating unit for generating a new task in the task layer of the workflow when new folder generation is requested by the external terminal.

3. The workflow management system as claimed in claim 1, wherein
when a document is uploaded for a specified folder in the folder layer, the appending unit appends the document to the task of the workflow corresponding to the specified folder as the relevant information.

4. The workflow management system as claimed in claim 1, wherein
when a document is uploaded without a folder in the folder layer being specified, the appending unit appends the document as the relevant information to a task of the workflow specified based on one of an updating time and a keyword of the document.

5. The workflow management system as claimed in claim 4, wherein when plural of the documents are uploaded in a package, the documents are divided into groups based on proximity of the updating time, and a task is specified for each of the groups.

6. A method of controlling a workflow management system wherein a workflow model is dynamically constituted when a workflow is executed, the method comprising:
a receiving step of receiving an access from an external terminal based on a protocol that can access a file system;
a providing step of providing a folder list to the external terminal, wherein the folder list is acquired by converting a task layer of the workflow managed by the workflow management system into a folder layer of the file system; and
an appending step of appending a document to the task of the workflow as relevant information, the task corresponding to a predetermined folder layer, when the document is uploaded by the external terminal.

7. The method of controlling the workflow management system as claimed in claim 6, further comprising:
a new task generating step of generating a new task in the task layer of the workflow when the external terminal requests generating a new folder.

8. The method of controlling the workflow management system as claimed in claim 6, wherein
when a document is uploaded to a specified folder of the folder layer, the document is appended as relevant information to the task of the workflow, the task corresponding to the specified folder at the appending step.

9. The method of controlling the workflow management system as claimed in claim 6, wherein
when a document is uploaded without a folder of the folder layer being specified,
the document is appended as relevant information to a task of the workflow based on one of updating time and a keyword of the document at the appending step.

10. The method of controlling the workflow management system as claimed in claim 9, wherein
when plural of the documents are uploaded in a package, the documents are divided into groups based on proximity of the updating time, and a task is specified for each of the groups.

11. A control program of a workflow management system wherein a workflow model is dynamically constituted when a workflow is executed, the control program, comprising:
a function for a computer to realize a receiving unit for receiving access an from an external terminal based on a protocol that can access a file system;
a function for the computer to realize a providing unit for providing the external terminal with a folder list that is acquired by converting a task layer of the workflow managed by the workflow management system into a folder layer of the file system; and
a function for the computer to realize an appending unit for appending a document as relevant information to a task of the workflow corresponding to a predetermined folder layer when the document is uploaded from the external terminal.

12. The control program of the workflow management system as claimed in claim 11, further comprising:
a function for the computer to generate a new task in the task layer of the workflow based on a request to generate a new folder from the external terminal.

13. The control program of the workflow management system as claimed in claim 11, wherein
when a document is uploaded for a specified folder in the folder layer, the document is appended as relevant information to a task of the workflow corresponding to the specified folder.

14. The control program of the workflow management system as claimed in claim 11, wherein
when a document is uploaded with no folder of the folder layer being specified, the document is appended as relevant information to a task of the workflow based on one of updating time and a keyword of the document.

15. The control program of the workflow management system as claimed in claim 14, wherein
if plural of the documents are uploaded in a package, the documents are divided into groups based on proximity of the updating time, and a task is specified for each of the groups.
